(19) United States
(12) Patent Application Publication
(10) Pub. No.: US 2023/0413117 A1
(43) Pub. Date: Dec. 21, 2023

(54) SEARCHLIGHT DISTRIBUTED QOS MANAGEMENT

(71) Applicant: Raytheon BBN Technologies Corp., Cambridge, MA (US)

(72) Inventors: Armando L. Caro, Jr., Somerville, MA (US); Aaron Mark Helsinger, Somerville, MA (US); Timothy Upthegrove, Townsend, MT (US); Mark Keaton, North Reading, MA (US)

(73) Assignees: Raytheon BBN Technologies Corp., Cambridge, MA (US); Raytheon BBN Technologies Corp., Cambridge, MA (US)

(21) Appl. No.: 18/112,301

(22) Filed: Feb. 21, 2023

Related U.S. Application Data
(60) Provisional application No. 63/333,297, filed on Apr. 21, 2022.

(51) Int. Cl. H04W 28/10; H04W 28/02; H04W 72/56

(52) U.S. Cl. CPC H04W 28/10; H04W 72/56; H04W 28/0263

(57) ABSTRACT

According to at least one aspect of the present disclosure, a method of managing flows on a network is provided. The method comprises: identifying a first flow on the network; identifying a second flow on the network; responsive to identifying the first flow, determining a priority of the first flow; responsive to identifying the second flow, determining a priority of the second flow; comparing the priority of the first flow to the priority of the second flow to determine which flow has the lower priority; and distributing bandwidth from a flow having lower priority to a flow having higher priority.

### CROSS-REFERENCE TO RELATED APPLICATIONS

This application claims priority under 35 U.S.C. § 119(e) to U.S. Provisional Application Ser. No. 63/333,297 titled “SEARCHLIGHT DATA QUALITY MANAGEMENT,” filed on Apr. 21, 2022, which is hereby incorporated by reference in its entirety for all purposes.

### STATEMENT REGARDING FEDERALLY SPONSORED RESEARCH OR DEVELOPMENT

This application was made with government support under Contract No. W911NF-19-C-0056 awarded by the US Army. The US Government may have certain rights in this invention.

### BACKGROUND

### 1. Field of the Disclosure

At least one example in accordance with the present disclosure relates generally to managing bandwidth distribution on telecommunication networks.

### 2. Discussion of Related Art

Modern telecommunication networks (“networks”) are used to transmit large quantities of data. Many networks use network switches to manage the transmission of data through the network. Some networks use network switches to manage the transmission or flow of data through the network. In general, a given network (or route through a network) will have a maximum rate of data transmission, called a maximum bandwidth, associated with it. Various applications and traffic using the network may use portions of the maximum bandwidth for their own communications.

### SUMMARY

According to at least one aspect of the present disclosure, a method of managing flows on a network is provided. The method comprises: identifying a first flow on the network;
identifying a second flow on the network; responsive to identifying the first flow, determining a priority of the first flow; responsive to identifying the second flow, determining a priority of the second flow; comparing the priority of the first flow to the priority of the second flow to determine which flow has the lower priority; and distributing bandwidth from a flow having lower priority to a flow having higher priority.

In various examples, distributing bandwidth from the flow having lower priority to the flow having higher priority includes determining that the flow having higher priority and the flow having lower priority share at least one bottleneck link. In many examples, the method further comprises determining a bandwidth of the flow having lower priority; determining a bandwidth of the flow having higher priority; and wherein distributing bandwidth from the flow having lower priority to the flow having higher priority includes distributing no more bandwidth than the bandwidth of the flow having the lower priority. In some examples, the method further comprises determining a target bandwidth for the flow having the higher priority; responsive to determining the target bandwidth, determining a bandwidth of the flow having the higher priority; determining that the bandwidth is below the target bandwidth; and wherein distributing bandwidth from the flow having the lower priority to the flow having the higher priority includes distributing an amount of bandwidth from the flow having the lower priority such that the bandwidth of the flow having the higher priority does not exceed the target bandwidth.

In various examples, distributing bandwidth includes using a competitive algorithm to distribute bandwidth, and the competitive algorithm is configured to favor the flow having the higher priority over at least one other flow. In many examples, the at least one other flow is the flow having the lower priority. In some examples, the at least one other flow is every flow present at a bottleneck link associated with the flow having the higher priority.

According to at least one aspect of the present disclosure, a method of distributing bandwidth on a network is provided. The method comprises: providing at least one rule; identifying at least two flows; responsive to identifying the at least two flows, assigning two or more flows of the at least two flows a respective priority based on the at least one rule; responsive to assigning the two or more flows of the at least two flows a priority, distributing bandwidth of at least one flow of the at least two flows to a different flow of the at least two flows.

In some examples, the method further comprises identifying at least one bottleneck link shared by the at least two flows. In various examples, the method further comprises identifying a bandwidth of a first flow of the at least two flows; identifying a bandwidth of a second flow of the at least two flows, the second flow having a priority lower than the first flow; and wherein distributing bandwidth of the at least one flow of the at least two flows to a different flow of the at least two flows includes distributing bandwidth from the second flow to the first flow. In various examples, the bandwidth distributed from the second flow to the first flow is less than or equal to the bandwidth of the second flow.

In many examples, the method further comprises determining a target bandwidth for flows having a first priority; wherein distributing bandwidth of the at least one flow of the at least two flows to a different flow of the at least two flows includes: determining whether the flows having the first priority have a bandwidth exceeding the target bandwidth; determining whether flows having a second priority, the second priority being less than the first priority, have bandwidth; responsive to determining that the flows having the first priority do not have a bandwidth exceeding the target bandwidth and the flows having the second priority have bandwidth, distributing bandwidth from at least one flow having the second priority to at least one flow having the first priority.

In many examples, distributing bandwidth includes using a competitive algorithm, wherein the competitive algorithm is configured to favor the different flow of the at least two flows over the at least one flow of the at least two flows.

According to at least one aspect of the present disclosure, a dynamic quality management (DWM) system is provided. The DQM system comprises a supervisor configured to provide bandwidth distributions for one or more flows; and an enforcer configured to receive the bandwidth distributions for the one or more flows, the enforcer being further configured to control a distribution of bandwidth for a first classification of flows routed through a network switch; and control a distribution of bandwidth for a second classification of flows routed through the network switch.

In some examples the enforcer is further configured to: monitor a flow rate of the first classification of flows; monitor a flow rate of the second classification of flows; and compare the flow rate of the first classification of flows to a target flow rate. In various examples, the enforcer is further configured to distribute bandwidth from the second classification of flows to the first classification of flows responsive to determining that the flow rate of the first classification of flows is below the target flow rate. In many examples, the enforcer is further configured to maintain the sum of the flow rate of the first classification of flows and the flow rate of the second classification of flows at an approximately constant level based on the bandwidth of the network switch. In some examples, the enforcer is further configured to identify a bottleneck link having at least one first flow of the one or more flows and at least one second flow of the one or more flows routed through a network switch associated with the bottleneck link. In various examples, the enforcer is installed on the network switch associated with the bottleneck link. In many example, the enforcer is configured to determine the network switch associated with the bottleneck link based at least on flow rate information associated with the one or more flows provided to the enforcer by at least one other enforcer.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a dynamic quality management system according to an example;

FIG. 2A illustrates a network according to an example;

FIG. 2B illustrates a network according to an example;

FIG. 2C illustrates a network according to an example;

FIG. 3A illustrates a graph showing various flows according to an example;

FIG. 3B illustrates a graph showing various flows according to an example;

FIG. 4 illustrates a process for distributing bandwidth according to an example;

FIG. 5 illustrates a supervisor according to an example;

FIG. 6 illustrates an enforcer according to an example; and

FIG. 7 illustrates a process for distributing bandwidth according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Telecommunication networks (“networks”), like the internet, facilitate the transmission of large amounts of data between nodes (such as routers, switches, computers, and the like). Networks are made up of network nodes (“nodes”), which may include network switches, routers, computers, applications, servers, and/or other network infrastructure. Nodes, in general, can route (or transmit) data to one another, allowing for information to travel from an origin node to a destination node in the network without necessarily having a direct connection between the origin and destination nodes.

In many cases, data transmitted on the network is transmitted in packets. To manage the large amounts of data, networks distribute the available bandwidth of the network. In most cases, a network protocol, such as TCP, manages bandwidth distribution. For example, a network might have an available bandwidth of 10 megabits per second (10 Mbps) for all connections on the network. The network protocol could distribute 7 Mbps to a video streaming service, 2 Mbps to a video game, and 1 Mbps to other network traffic. Many network protocols such as the transmission control protocol (TCP) attempt to divvy bandwidth evenly, such that each network connection gets an even share of the available bandwidth. Thus, with TCP, each network connection would receive approximately 3.333 Mbps, for a uniform distribution of bandwidth. The network protocol itself may be agnostic as to how bandwidth is distributed. That is, the network protocol does not necessarily prioritize any particular kind of network traffic. Instead, as is the case with TCP/IP, the network protocol may use algorithms designed to distribute bandwidth in a “fair” manner, as defined by the protocol itself. Many algorithms and methods exist to manage bandwidth, including traffic shaping, packet scheduling, cubic congestion control algorithms, and so on.

However, with most network protocols, the users of the network have no way of controlling the bandwidth distributed to them by the network protocol. For example, a user might have multiple network connections open (e.g., multiple applications having possibly different ports and possibly different IP addresses may be running under the user's control, each application sending data using the network). The network protocol may assign each of the user's network connections some portion of the total bandwidth available on the network. The remaining bandwidth (if any) may be distributed to other users (for example, the general public). As a result, the user has a bundle of bandwidth (referred to herein as the “enterprise capacity”) available equal to the sum of the bandwidth distributed by the network protocol to each of the user's network connections. However, the user has not determined how much of the enterprise capacity is distributed to any given network connection. Instead, the network protocol has assigned each of the user's network connection an amount of bandwidth based on the network protocol's bandwidth distribution algorithm.

The user may prioritize their own network connections differently than the network protocol. That is, the user may prefer that one or more of the user's network connections get a larger share of the enterprise capacity. However, if the user is “greedy” and takes bandwidth being used by the general public (e.g., other users), the user may detrimentally impact the ability of other users to user the network. Furthermore, other users in the general public may retaliate by engaging in greedy behavior of their own, possibly resulting in the user having less enterprise capacity available than the user started with. Furthermore, the network service provider (for example, an internet service provider (ISP) in the case of the internet) may monitor for and throttle connections that are too greedy, thus negatively impacting the user's network connections and/or enterprise capacity.

Therefore, the user may wish to acquire additional bandwidth for a given network connection without impacting the bandwidth available to the general public (e.g., the user may not want to significantly change their enterprise capacity; the user may simply want to reassign bandwidth between their own network connections while maintaining a constant or approximately constant enterprise capacity). By being able to reassign bandwidth between network connections while maintaining a constant or approximately constant enterprise capacity, the user can respect the distribution of bandwidth by the network protocol while also managing the prioritization of the user's own network connections by controlling the relative share of the enterprise capacity distributed to a given network connection.

Aspects and elements of the present disclosure relate to providing a user with the ability to redistribute bandwidth between network connections within the user's enterprise capacity without significantly affecting the bandwidth available to the general public on a network.

Using the methods and systems described herein, the user can take the bandwidth distributed to their applications and/or network connections by the network, and redistribute and/or redistribute that bandwidth among the user's own applications and/or network connections without significantly impacting the bandwidth available to other users. As an example, suppose the user has a first, second, and third application running. Suppose the network has 10 Mbps of total bandwidth, and distributes 5 Mbps and 1 Mbps to each of the second and third applications. Using the methods and systems described herein, the user can redistribute the enterprise capacity. The user still has only 5 Mbps total bandwidth to manage, but can shift the bandwidth around between their applications and/or network connections. For example, the user can take the 3 Mbps distributed to the first application, and redistribute a portion of that bandwidth to the second or third applications. As another example, the user could take 2.5 Mbps from the first application and provide all or part of the 2.5 Mbps to the third application. Thus, the applications could end up with 0.5 Mbps, 1 Mbps and 3.5 Mbps respectively, between the first, second, and third applications. Other redistributions of bandwidth are also possible.

Furthermore, aspects of elements of the present disclosure are not necessarily limited to telecommunication networks, but may be used in any system where information is transmitted at distributed rates.

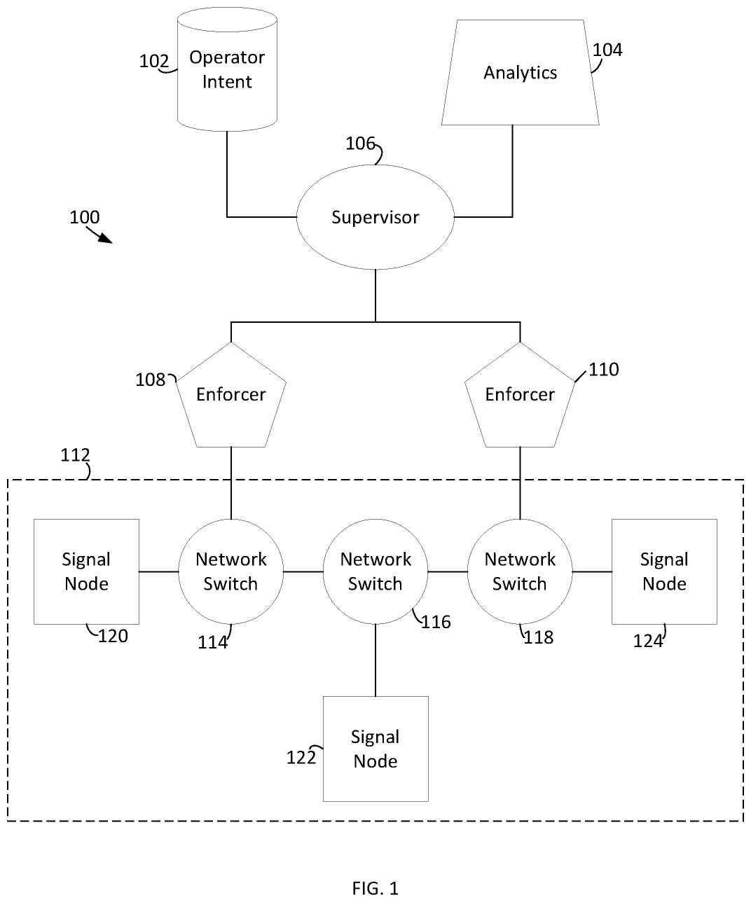

FIG. 1 illustrates a Dynamic Quality Management System 100 (“DQM 100”) according to an example. The DQM 100 is, in some examples, a Distributed Quality of Service (QoS) Management system for network traffic or bandwidth on a network. The DQM 100 can discriminate between different kinds of network traffic or network connections (called flows, discussed more below) and dynamically redistribute bandwidth between the different kinds of flows, thus allowing a user to control bandwidth distribution on a network. In particular, the DQM 100 allows a user to redistribute bandwidth within the enterprise capacity distributed to the user by a network protocol such as a transport protocol.

FIG. 1 includes a database of operator intent 102 (“rules database 102”), an analytics system 104 (“analytics 104”), a supervisor 106, a first enforcer 108, a second enforcer 110, and a network 112. The network includes a first network switch 114 (“first switch 114”), a second network switch 116 (“second switch 116”), a third network switch 118 (“third switch 118”), and one or more signal nodes 120, 122, 124.

The rules database 102 and analytics 104 may be communicatively coupled to the supervisor 106. The supervisor 106 is communicatively coupled to the enforcers 108, 110. The first enforcer 108 is installed on the first network switch 114, and the second enforcer 110 is installed on the third network switch 118. The first network switch 114 is coupled to a signal node 120 and the second network switch 116. The second network switch 116 is coupled to the other two network switches 114, 118 and to a signal node 122. The third network switch 118 is coupled to the second network switch 116 and a signal node 124. In some examples, the switches 114, 116, 118 and signal nodes 120, 122, 124 are communicatively coupled but not necessarily physically coupled.

In some examples, the enforcers, such as the enforcers 108, 110 of FIG. 1, are installed directly on one or more network nodes (such as the switches or signal nodes). In other examples, the enforcers are not installed on the one or more network nodes, but are capable of controlling the one or more network nodes remotely.

The signal nodes 120, 122, 124 may be network nodes that originate network connections (called “flows”) on the network. In some examples, the signal nodes 120, 122, 124 also receive flows. The signal nodes 120, 122, 124 may be network switches, routers, modems, computers, or any other device capable of transmitting on the network.

Flows are network connections and/or network traffic. In some examples, flows are TCP connections, though any type of network connection may constitute a flow. In some examples, flows are identified by at least one internet protocol (“IP”) address and/or at least one port number. Multiple flows can also be associated with one another and treated as a single flow. In some examples, the flows are associated with or have a bandwidth on the network corresponding to the amount of data being sent over an interval of time via the flow (for example, megabytes per second (MB/s) or other measures of data transmission rates). Flows associated with the user (that is, flows that originate with the user or within the user's control) are called “enterprise flows.” Other types of flows may be called “public” or “non-enterprise” flows.

The network switches 114, 116, 118 route the flows through the network. Network switches are nodes that may be any device capable of packet switching, and/or any device capable of routing traffic through the network. The network switches 114, 116, 118 may take flows originating from one of the signal nodes 120, 122, 124 and route those flows to another signal node 120, 122, 124. For example, flows originating at the first signal node 120 may be routed to the third signal node 124 by the switches 114, 116, 118. The first switch 116 would receive the flow and route the flow to the second switch 116, which would in turn route the flow to the third switch 118. The third switch 118 would route the flow to the third signal node 124.

Taken together, the switches 114, 116, 118, with or without the signal nodes 120, 122, 124, form at least part of a network 112. The network may be associated with one or more network protocols (such as the internet protocol — including the transmission control protocol (TCP)). That is, the network may handle the routing and processing of flows according to the network protocols associated with the network. The supervisor and enforcers 108, 110 can manage bandwidth distribution on the network 112.

The rules database 102 contains a set of rules, heuristics, preferences, or other controls (“rules”) for flows on the network 112. In some examples, the rules apply only to enterprise flows, though rules can also apply to non-enterprise flows. In some examples, the rules database 102 contains at least a desired bandwidth distribution for one or more flows. The rules database 102 may be accessed by the supervisor 106. The rules database 102 may provide the supervisor 102 with the rules. The rules may be updated over time by a user or other entity, and the rules may be general or specific. For example, a single rule may apply to all traffic on the network 112, or a single rule may apply to only a single node (such as a network switch or signal node) on the network 112.

The analytics 104 provide information related to flows to the supervisor 106, including port identification numbers, IP addresses, source and destination information, or other information that can be used to identify a given flow. The primary purpose of the analytics 104 is to receive rules from the supervisor 106 that will be used to find and identify flows that the supervisor 106 wants to manipulate. For example, support the supervisor 106 provides a rule that all flows related to streaming video should be high priority. Then the analytics 104 may identify some or all video streaming flows and provide the supervisor 106 with information about those flows. In some examples, the analytics 104 collect at least the IP addresses and port numbers associated with a given flow.

The supervisor 106 uses the rules database 102 to provide rules for use on the network 112. The supervisor 106 can categorize flows as high (“gold”) priority or low (“bronze”) priority, and may be able to distinguish enterprise flows from non-enterprise (“silver”) flows. Non-enterprise flows are flows not associated with the user. The supervisor 106 may also use the analytics information and the rules database rules to determine the bandwidth to be distributed to various flows on the network 112. In some examples, the supervisor 106 uses a model or game to distribute bandwidth for the various flows. The model or game may be a zero-sum game. The supervisor 106 can prioritize one classification of flow above another classification of flow, ensuring that one classification of flow always outcompetes one or more other classifications of flow. For example, the supervisor 106 may use the game or model (e.g., the zero-sum game) to distribute more bandwidth to the gold flows compared to the bronze flows. The supervisor 106 may also require that the bandwidth distribution of one flow be drawn from the bandwidth of another flow. For example, the supervisor 106 may distribute bandwidth from the bronze flow to the gold flows. In many examples, the supervisor 106 provides rules and adjustments for the enforcers 108, 110 that ensure only bandwidth from bronze and gold flows (that is, enterprise flows) is redistributed, while non-enterprise flow bandwidth is left unaffected.

The supervisor 106 provides the bandwidth distribution for the various flows to the enforcers 108, 110. In some examples, the supervisor 106 provides a game or model that ensures the high priority flows always outcompete lower priority flows and uncategorized flows, even when the bandwidth distributed to uncategorized flows is not (or will not) be changed. In various examples, the supervisor 106 may provide rules indicating that only the user's enterprise capacity (that is, only enterprise flows) are to be affected.

The enforcers 108, 110 may be installed on network switches, for example the first and third network switches 114, 118. Enforcers 108, 110 may be installed opportunistically. The enforcers 108, 110 can control the network switches they are associated with (for example, the network switches the enforcers 108, 110 are installed on) to provide bandwidth to the data flows according to the distributions laid out by the supervisor 106. For example, various flows assigned different priorities by the supervisor 106 may be passing through the first network switch 114. The enforcer 108 may adjust the operation of network switches and/or the distribution of bandwidth by until the bandwidth distribution provided by the supervisor 106 is met. The enforcer 108 may, for example, report bandwidth utilization to the supervisor 106 and receive updated instructions from the supervisor 106 based on the feedback information. In particular, the supervisor 106 may tell the enforcer 108 to restrict a flow to a given bandwidth, or to alter a network parameter related to bandwidth to cause a change in the bandwidth of one or more flows. Based on the supervisor's instructions, the enforcer 108 may limit bandwidth redistribution to only selected flows. For example, the enforcer 108 may only take bandwidth from low priority (bronze) flows and redistribute that bandwidth to high priority (gold) flows, while not affecting the bandwidth available to uncategorized (silver) flows.

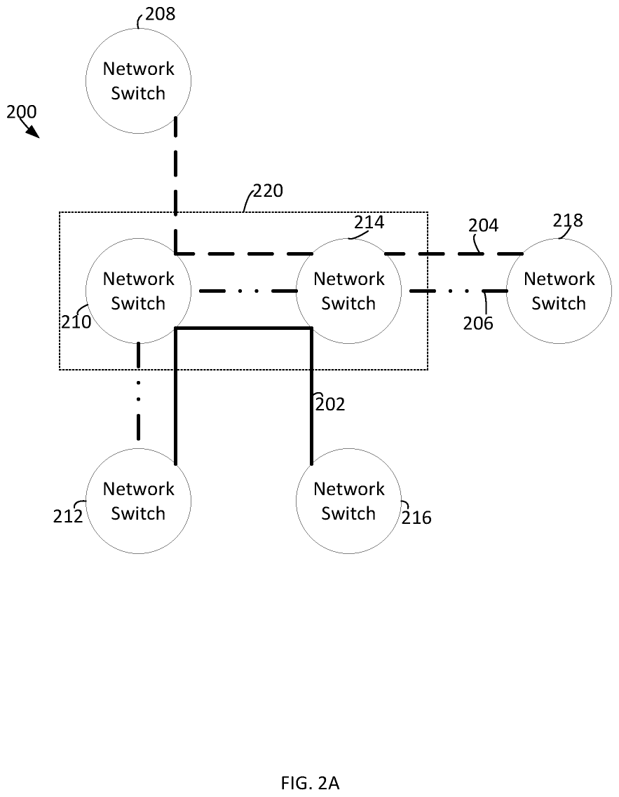

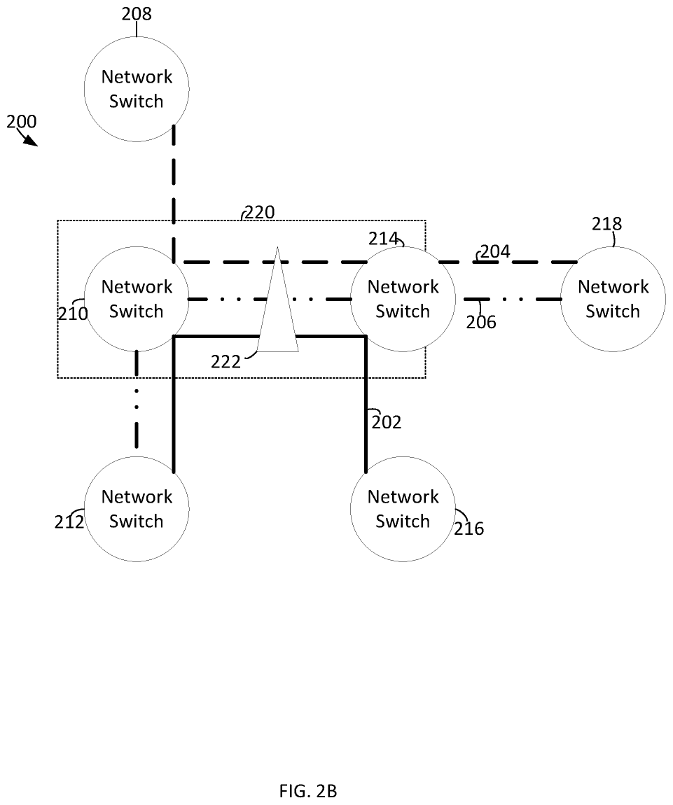

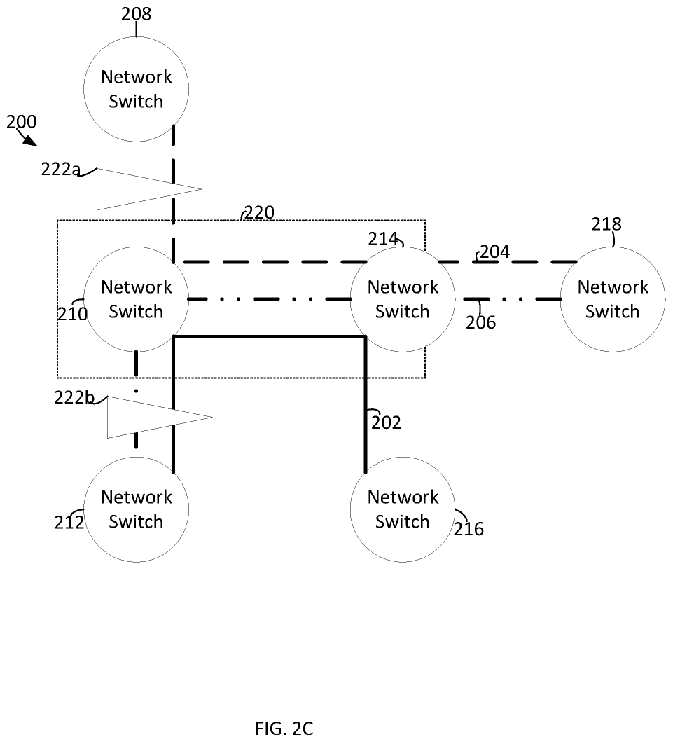

FIG. 2A illustrates a network 200 according to an example. The network 200 has three flows on it, a first flow 202, a second flow 204, and a third flow 206. The flows are being routed by a plurality of network switches, including the first network switch 208, the second network switch 210, the third network switch 212, the fourth network switch 214, the fifth network switch 216, and the sixth network switch 218. The second and fourth network switches 210, 214 comprise a bottleneck link 220.

The first flow 202 is a high priority (gold) flow. The second flow 204 is a low priority (bronze) flow. The third flow 206 is a non-categorized (silver) flow. In some examples, this means the first and second flows 202, 204 are enterprise flows and the third flow 206 is a non-enterprise flow.

The first network switch 208 is coupled to the second network switch 210. The second network switch 210 is coupled to the first, third, and fourth network switches 208, 212, 214. The third network switch 212 is coupled to the second network switch 210. The fourth network switch 214 is coupled to the second, fifth, and sixth network switches 210, 216, 216. The fifth and sixth network switches 216, 218 are each coupled to the fourth network switch 214. In some examples, the network switches are physically coupled to one another. In some examples, the network switches are communicatively coupled to one another. In some examples, the network switches are physically and/or communicatively coupled to one another.

The second and fourth switches 210, 214 comprise a bottleneck link 220. A bottleneck link is a link between two switches where at least one high priority flow (e.g., the first flow 202) and at least one low priority flow (e.g., the second flow 204) are present (that is, it is a link both flows are routed through) and the bandwidth of the high priority flow can be adjusted by changing the bandwidth of the low priority flow. Bottleneck links may change over time or as conditions in the network 200 change. For example, a bottleneck link may cease to be a bottleneck link for a gold flow as bandwidth from a bronze flow is distributed to the gold flow at that link. It is possible that the bronze flow provides all the bandwidth it can to the gold flow, and the gold flow does not reach its target bandwidth. Therefore, the bottleneck link for the gold flow may have shifted to a different node, and a different bronze flow will need to distribute bandwidth to the gold flow to reach the gold flow's target bandwidth. Some networks may have more than one bottleneck link for a given flow. Bottleneck links are defined relative to flows, as well. Thus, a bottleneck link for one flow may be different than a bottleneck link for another flow.

Enforcers (such as the enforcers of the DQM 100 of FIG. 1) may be installed on or otherwise present at one or more of the network switches of the network 200 or on one or more of the links between network switches of the network 200. The enforcers can redistribute bandwidth at a given link to force the bandwidth of the first flow 202 to increase as the bandwidth of the second flow 204 decreases. In some examples, the enforcers (and accompanying supervisor and the other parts of the system) can redistribute bandwidth between the first flow 202 and second flow 204 while leaving the third flow 206 unaffected.

FIG. 2B illustrates the network 200 of FIG. 2A with an enforcer 222 shown installed on the bottleneck link 220 according to an example. The enforcer 222 may be installed on one or both of the second and fourth network switches 210, 214. In one example, the enforcer 222 controls at least one of the first and fourth network switches 210, 214 to distribute less bandwidth to the second flow 204 and more bandwidth to the first flow 202. In some examples, the enforcer 222 may implement a zero-sum game wherein the first flow 202 outcompetes the second and third flows 204, 206 for bandwidth previously distributed to the second flow 204. As a result, the first flow 202 will gain bandwidth and the second flow 204 will lose bandwidth. In some examples, the bandwidth of the third flow 206 will remain unchanged.

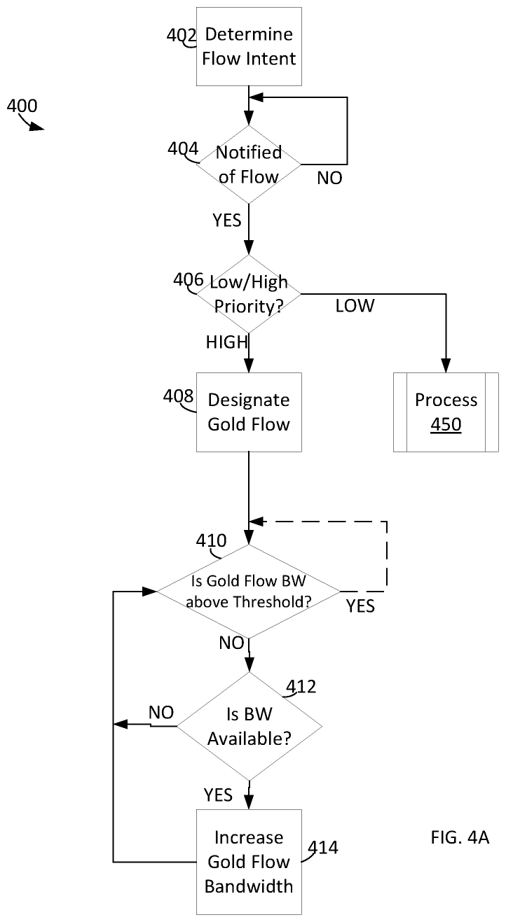

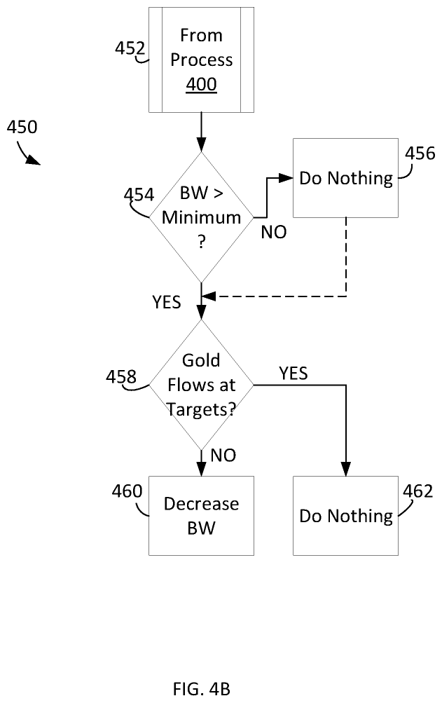

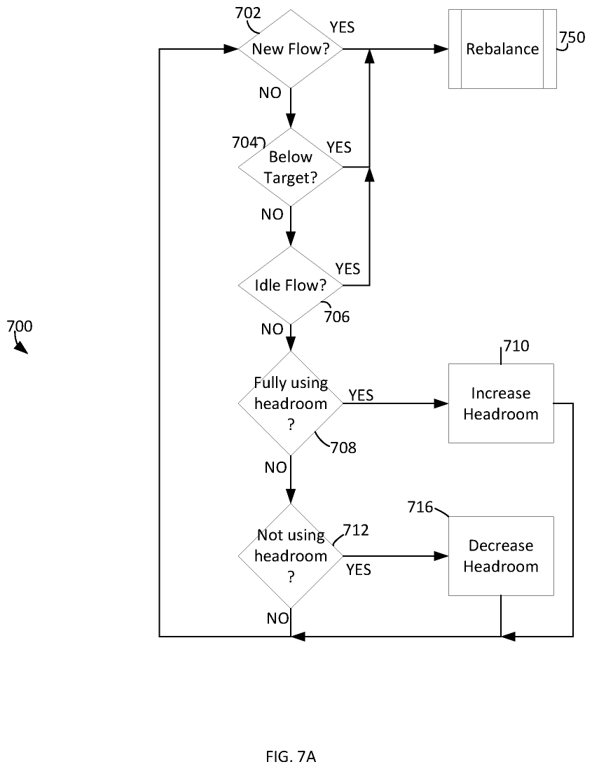

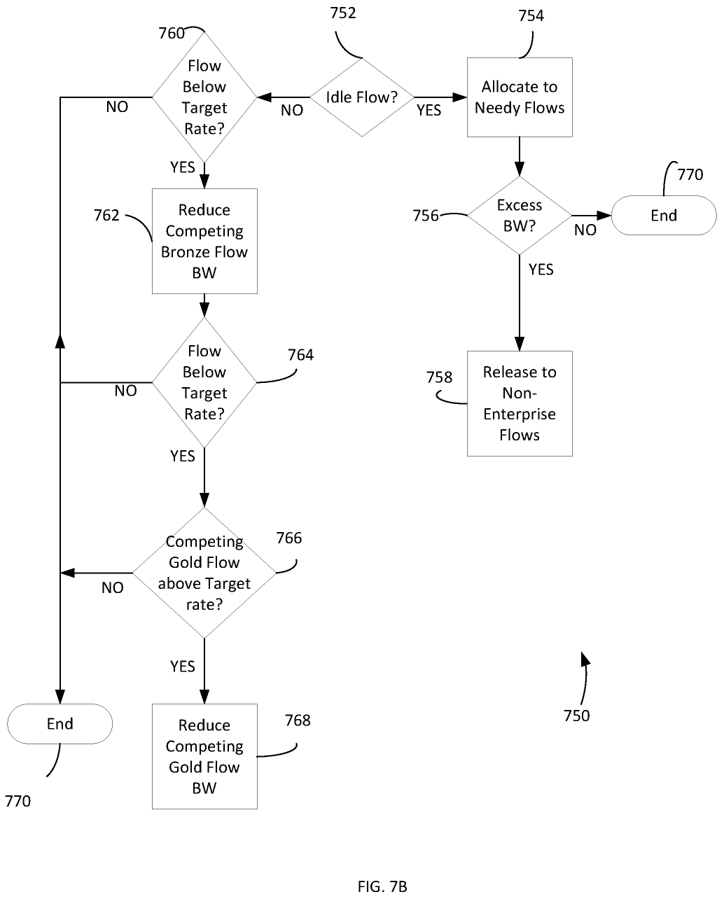

The enforcer 222 can implement the bandwidth redistribution in a variety of ways. For example, the enforcer 222 can instruct one or more of the second or fourth network switches 210, 214 in the bottleneck link 220 to delay sending packets associated with the second flow 204. The enforcer 222 can work in tandem with the supervisor 106. The supervisor 106 can use a “probe and go” approach, where it probes for available bandwidth and provides instructions to the enforcer 222 that would cause the enforcer to adjust parameters on the network such that the bandwidth is claimed for the first flow 202. Various methods of redistributing bandwidth will be discussed with greater detail below, including with respect to FIGS. 4 and 7.

FIG. 2C illustrates the network 200 of FIG. 2A with multiple enforcers 222 shown installed on links according to an example. In contrast to FIG. 2B, the enforcers 222 are not installed on the bottleneck link 220. Nonetheless, the enforcers 222 are still able to redistribute bandwidth from the second flow 204 to the first flow 202.

In this example, a first enforcer 222a is installed on the link between the first network switch 208 and the second network switch 210, and a second enforcer 222b is installed on the link between the second network switch 210 and the third network switch 212. However, the enforcers could be installed on other links instead, or on more links. For each link, the enforcers 222a, 222b may be installed on one or more of the network switches associated with that link.

Because the enforcers 222a, 222b are not installed on the bottleneck link 220, the enforcers 222a, 222b may work together to redistribute bandwidth to the first flow 202 from the second flow 204. To accomplish this, the first enforcer 222a can decrease the bandwidth distributed to the second flow 204, such that more “downstream” bandwidth is freed up, for example, at the bottleneck link. At the bottleneck link 220, the network protocol (e.g., the TCP/IP protocol) may attempt to distribute bandwidth. For example, TCP evenly splits bandwidth as a default behavior. Assuming the network protocol evenly splits the bandwidth freed from the second flow 204 between the first flow 202 and the third flow 206 at the bottleneck link 220, the first flow 202 would have more bandwidth but the user would overall see a reduction in their enterprise capacity—that is, the net bandwidth distributed to both the first and second flows 202, 204 would decrease as the third flow 206 would receive some of the bandwidth of the second flow 204 per operation of the network protocol.

However, the second enforcer 222b can work in tandem with the first enforcer 222a to ensure the first flow 202 receives all the bandwidth from the second flow 204. In some examples, the various enforcers can report the data rates of the various flows to the supervisor. The supervisor can then provide instructions to the enforcers such that the enforcers implement policies (e.g., parameter adjustments) that cause the first flow 202 to outcompete the third flow 206, such that the bandwidth of the third flow 206 remains constant or approximately constant while the first flow 202 absorbs the freed bandwidth of the second flow 204. In particular, in some examples, the first and second enforcers 222a, 222b can report the change in the bandwidth of the second flow 204 to the supervisor, and the supervisor can implement a game where the first flow 202 increases its own bandwidth by the amount of bandwidth the second flow 204 loses.

In each of the foregoing examples, the enforcers can also ensure the bandwidth of the third flow 206 remains constant or approximately constant in proportion to the first and second flows 202, 204. That is, if the first flow 202 uses X% of the total bandwidth, and the second flow 204 uses Y% of the total bandwidth, the enforcers can ensure that the total bandwidth used by the first and second flows 202, 204 remains constant or approximately constant at (X+Y)% of the total bandwidth regardless of changes in the total amount of bandwidth available on the network. In this way, the enterprise capacity of the user scales to the total bandwidth available to the network as a percentage of the bandwidth of the network. In some examples, the supervisor provides rules that cause the enforcers to distribute the bandwidth in the manner described herein.

In some examples, the enforcers can allow the proportion of enterprise capacity to total network bandwidth to vary. For example, if the network protocol would increase the total bandwidth available to an enterprise flow, the enforcers can accept this additional bandwidth and then redistribute it.

From the examples of FIGS. 2A, 2B, and 2C, it should be understood that enforcers can be placed anywhere in a network. Provided the enforcers can report to the supervisor and control the low and high priority flows, the enforcers can implement policies that redistribute bandwidth between the high and low priority flows even without direct access to a bottleneck link.

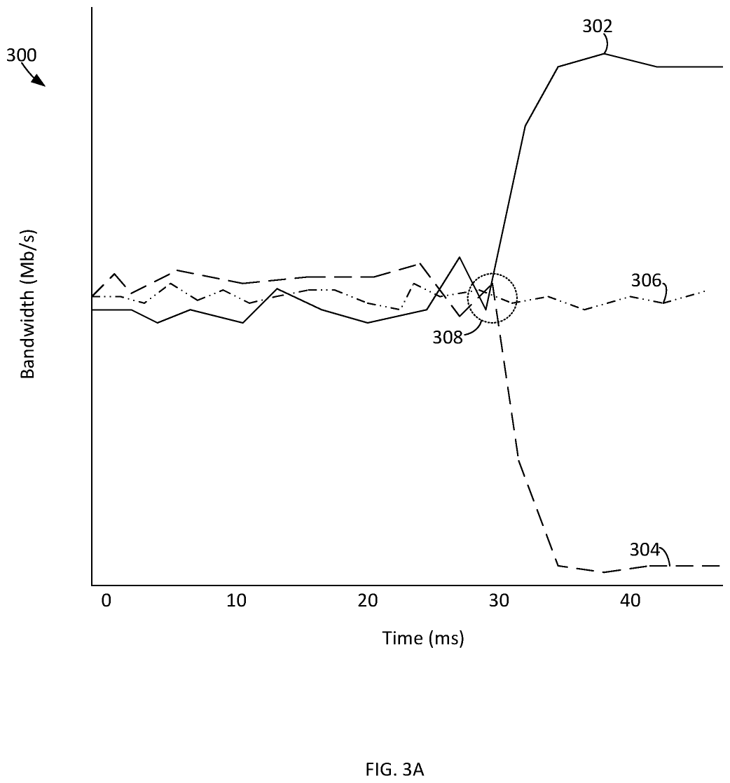

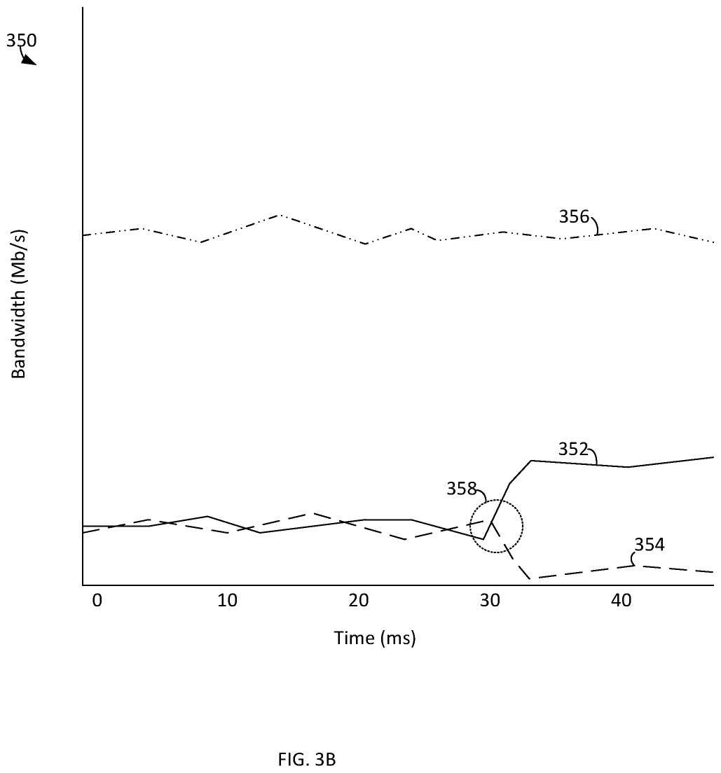

FIG. 3A illustrates a graph 300 showing a first flow 302, a second flow 304, and a third flow 304 before and after at least one enforcer begins to enforce a bandwidth distribution according to an example.

The graph 300 shows relative bandwidth distribution between three flows. The first flow 302 is a high priority (gold) flow, the second flow 304 is a low priority (bronze) flow, and the third flow 306 is a non-categorized (silver) flow. Then at least one enforcer begins enforcing bandwidth distribution at a time corresponding to the circle 308.

As shown from approximately 0 ms to 30 ms, each of the flows 302, 304, 306 are approximately constant (given some variation due to the dynamics of end-to-end congestion control's bandwidth distribution algorithm). At circle 308, from approximately 30 ms onward, the at least one enforcer begins to enforce bandwidth distribution rules along at least one link in the network (that is, at one or more network switches in the network). The enterprise capacity of the first and second flows 302, 304 remains unchanged from the circle 308 onwards, however, the first flow 302 gets the majority (up to all) of the bandwidth of the second flow 304, while the third flow 306 remains approximately constant. In some examples, the second flow 304 has a minimum bandwidth determined by the supervisor and enforced by the enforcers, and the first flow 302 can only take bandwidth from the second flow 304 up to an amount that would place the second flow 304 at its minimum bandwidth level.

FIG. 3B illustrates a graph 350 according to an example. The graph 350 is similar to the graph 300 of FIG. 3A. The graph 350 includes a first flow 352, a second flow 354, and a third flow 356. The graph 350 also includes a circle 358 corresponding to when at least one enforcer begins to enforce bandwidth distribution rules on the network. The first flow 352 is high priority, the second flow 354 is low priority, and the third flow 356 is non-categorized.

As with FIG. 3A, the three flows 352, 354, 356 remain approximately constant (given some variation due to the dynamics of end-to-end congestion control's bandwidth distribution algorithm) for the first approximately 30 ms. After 30 ms, at circle 358, the at least one enforcer begins enforcing bandwidth distribution rules, and the first flow 352 receives the bandwidth of the second flow 354, while the bandwidth of the third flow 356 remains approximately constant.

In the foregoing graphs 300, 350, the relative bandwidth distributed to each flow is arbitrary. Any amount of bandwidth could initially be distributed to any particular flow. Likewise, the timeframe shown is arbitrary. Although the time shown is milliseconds, it could also be a larger timeframe (for example, seconds) or a smaller timeframe (for example, nanoseconds).

Each flow may also represent an aggregate of similarly classified flows. For example, the first flow 352 of FIG. 3B could represent all flows categorized as high priority. With respect to

FIGS. 3A and 3B, the flows (e.g., first flow 352, second flow 354) need not be single flows, but could also represent an entire class of flows (e.g., the first flow 352 could represent a multitude of high priority flows sharing the same priority). Under TCP, as an example, each aggregation of flows would receive bandwidth proportional to the number of flows in that multitude relative to the total number of flows.

FIG. 4A illustrates a process 400 for distributing bandwidth among flows according to an example. The process 400 may be carried out by one or more controllers, for example, one or more enforcers, supervisors, and so forth.

At act 402, the supervisor determines the user intent and provides various targets and/or adjustments to be implemented on the network. For example, the supervisor may determine that flows of applications or services of a given type should be prioritized over other flows of a different type. The supervisor may, for example, have identified a particular class of flows that should be categorized as gold flows, and another class that should be classified as bronze. The supervisor may provide the desired flow characteristics to an analytics system (e.g., analytics system 104). The supervisor may also provide bandwidth targets to the enforcers, as well as adjustments (possibly in the form of rules) that the enforcers are to enforce on the network. bandwidth targets may include minimum bandwidth allowed for bronze flows as well as the minimum target bandwidth for gold flows. The supervisor may also determine what adjusts to a network switch or switches on a network (possibly at a bottleneck on the network) would effectuate the desired changes in bandwidth. The process 400 may then proceed to act 404.

At act 404, the analytics system provides a flow or multiple flows matching the characteristics of the flows the supervisor has determined should be labeled as gold or bronze. The analytics may, for example, provide identifying information that can be used by the enforcers to implement the bandwidth redistribution determined by the supervisor based on the user intent. Once at least one flow is received by the supervisor and/or the supervisor is notified of at least one flow of interest (404 YES), the process 400 may continue to act 406. If no flow is received (404 NO), the process 400 may terminate or may wait at this act 404 until a flow is provided by the analytics system (e.g., until the condition for 404 YES is met).

At act 406, the process 400 branches depending on the priority of the flow. If the flow is gold or high priority (406 HIGH) the process 400 continues to act 408. If the flow is bronze or low priority (406 LOW), the process 400 continues to process 450, which will be described in greater detail with respect to FIG. 4B. In many examples, the supervisor has already implemented rules that dictate what flows the analytics will provide. In some examples, the analytics may predetermine the priority of a given flow and provide that information to the supervisor or another part of the system.

At act 408, the supervisor and/or analytics designates a flow as a gold flow (that is, high priority). The process 400 may then continue to act 410.

At act 410, the supervisor determines if the bandwidth of the gold flow is above the minimum target bandwidth. The supervisor may receive, from either the enforcer or the analytics, information relating to the current bandwidth of the gold flow. If the supervisor determines that the bandwidth of the gold flow is above the minimum target bandwidth (410 YES), the process may terminate or return to act 402 to further iterate with respect to new or additional flows. If the supervisor determines the gold flow is below the minimum target bandwidth (410 NO), the process 400 may continue to act 412.

At act 412, the supervisor or analytics determine if bandwidth is available for redistribution. If the supervisor and/or analytics determine there is no bandwidth available for redistribution (412 NO), the process 400 may return to act 410. The supervisor and/or analytics may determine whether bandwidth is available in any number of ways. In one example, the supervisor and/or analytics may examine the bandwidth distributed to bronze flows and determine that each bronze flow is at the minimum bandwidth determined for that class of bronze flow. In such a case, since the system as a whole is designed to leave the silver (non-enterprise) flow bandwidth constant, the system (e.g., the supervisor) may determine that there are no available bronze flows from which to redistribute bandwidth, and thus no way to increase the bandwidth of the gold flows. If the supervisor and/or analytics determine there is bandwidth available (either bandwidth distributed to bronze flows in excess of the minimum bandwidth of the bronze flow, or bandwidth distributed to gold flows in excess of the target minimum bandwidth, and so forth) (412 YES), the process 400 continues to act 414.

At act 414, the enforcers, executing rules set by the supervisor, cause—via the execution of those rules—bandwidth to be distributed to the gold flows having a bandwidth below the minimum target bandwidth. During this act, there may be a priority for from where and when to redistribute bandwidth. The priority may be implicitly or explicitly implemented by the supervisor's rules. As one example, the execution of the rules by the enforcer may cause bandwidth from bronze flows in excess of the minimum bandwidth of the bronze flows to be redistributed to gold flows first, and bandwidth from gold flows in excess of the minimum target bandwidth of the gold flows to be redistributed to gold flows. In some examples, gold flows below the minimum target bandwidth will be prioritized to receive bandwidth before gold flows above the minimum target bandwidth, and so forth.

FIG. 4B illustrates a parallel process 450 for distributing bandwidth to or from bronze flows.

At act 452, the process 450 begins, following a decision that the flow of FIG. 4A is low priority. The process 450 then continues to act 454.

At act 454, the supervisor and/or analytics determine whether the bandwidth of the bronze flows is above a prior determined minimum bandwidth. If the supervisor and/or analytics determine the bronze flows are above the minimum bandwidth (454 YES), the process 450 may continue to act 458. If the supervisor and/or analytics determine that the bronze flows are below the minimum bandwidth (454 NO), the process 450 may continue to act 456. The supervisor and/or analytics may determine the bandwidth of the bronze flows using sensors or any other available method. The minimum bandwidth of the bronze flows may be any value, including zero.

At act 456, no bandwidth is redistributed. In some examples, no bandwidth is redistributed because the bronze flows are already at the minimum bandwidth and are not permitted (by the supervisor's rules) to go lower.

At act 458, the supervisor and/or analytics determine whether the gold flows are at or above the minimum target bandwidth. If the supervisor and/or analytics determine that the gold flows are at or above the minimum target bandwidth (458 YES), the process 450 may terminate or may continue to optional act 462. If the supervisor and/or analytics determines that the gold flows are below the minimum target bandwidth, the process 450 continues to act 460.

At act 460, the supervisor provides rules for implementation by the enforcers that cause bandwidth to be distributed from the bronze flows to the gold flows. That is, the total bandwidth of the bronze flows decreases and the total bandwidth of the gold flows increases as the enforcers enforce policies that cause the gold flows to outcompete the bronze flows. The redistribution of bandwidth from bronze to gold flow can continue until the bronze flows are at or below the minimum bandwidth.

At act 462, no bandwidth is redistributed. In some examples, no bandwidth is redistributed because the bronze flows are already at the minimum bandwidth and are not permitted (by the supervisor's rules) to go lower.

In some examples, act 456 may optionally lead to act 458, as it is possible that the gold flows are at or above their respective target bandwidths and bandwidth is available to be provided to the bronze flows such that the bronze flows reach their respective minimum bandwidths.

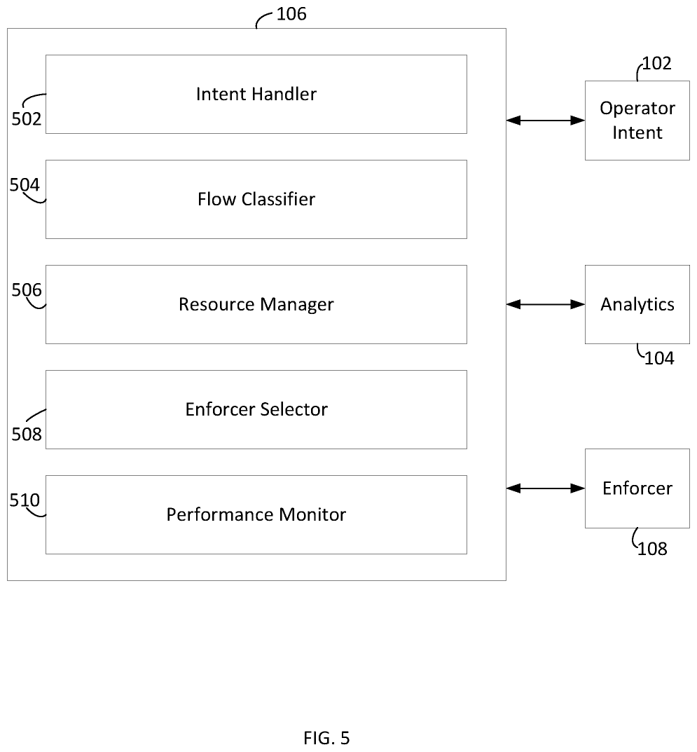

FIG. 5 illustrates a supervisor 106 in greater detail according to an example. The supervisor 106 is shown coupled to the analytics system 104, the rules database 102, and the first enforcer 108 of FIG. 1.

The supervisor 106 includes an intent handler module 502, a flow classifier module 504, a resource manager 506, an enforcer selection module 508, and a performance monitor 510.

The intent handler module 502 processes the rules provided by the rules database 102. The intent handler module 502 can convert the user's intent—as expressed by the rules contained in the rules database 102—into a form that can be used to set a desired Quality of Service level for one or more flows. The Quality of Service (QoS) level may include the bandwidth distribution for a given flow based on the flow's priority level, as well as other QoS metrics (such as packet loss rates, network jitter, latency, and so forth).

The rules may be general (that is, applying to the entire network as a whole), or specific (that is, applying to specific subsets of the network or to specific nodes or sets of nodes within the network).

The flow classifier module 504 processes flows identified by the analytics system 104 according to the rules of the rules database 102. In particular, the flow classifier module 504 may identify those flows that should be classified as high priority and/or low priority. In some examples, the flow classifier module 504 can classify only enterprise flows, and in some examples the flow classifier module 504 can classify enterprise and/or non-enterprise flows. The flow classifier module 504 may determine the classification of a flow based on the processed rules provided by the intent handler module 502.

The resource manager 506 determines a quality of service level for a flow. The resource manager 506 can assign a QoS level to a flow based on the classification of the flow as determined by the flow classifier module 504. The QoS level assigned to a flow can include a target bandwidth for that flow. That is, the QoS level assigned to the flow can include the portion of the enterprise capacity to be distributed to the flow, or the QoS level can include the portion of total network bandwidth to distribute to a flow. In some examples, the resource manager 506 may assign QoS levels based on the processed rules provided by the intent handler module 502.

The enforcer selection module 508 determines which enforcers are associated with which flows. For example, the enforcer selection module 508 may analyze available data about the network and/or flows to determine one or more bottleneck links for one or more flows. The enforcer selection module 508 may then determine a set of one or more enforcers to assign a flow such that the flow receives a desired QoS based on the processed rules of the intent handler module 502. The assigned enforcers then control the network switches (or other nodes) associated with the assigned enforcers to provide the desired QoS. In some examples, the assigned enforcers will ensure that the flows to which they are assigned receive an distribution of the enterprise capacity that reflects the target QoS levels set by the resource manager 506. In some examples, the enforcer selection module 508 may be configured to determine a minimum set of enforcers needed to provide the desired QoS.

The performance monitor 510 monitors at least the flows classified by the flow classifier module 504 (for example, the enterprise flows), but may monitor other flows as well (for example, the non-enterprise flows). The performance monitor 510 is configured to determine whether a flow has the desired QoS level (for example, the desired bandwidth), and can provide feedback to the other modules of the supervisor 106 so that QoS levels can be adjusted and/or enforcers can take action to enforce the desired QoS levels.

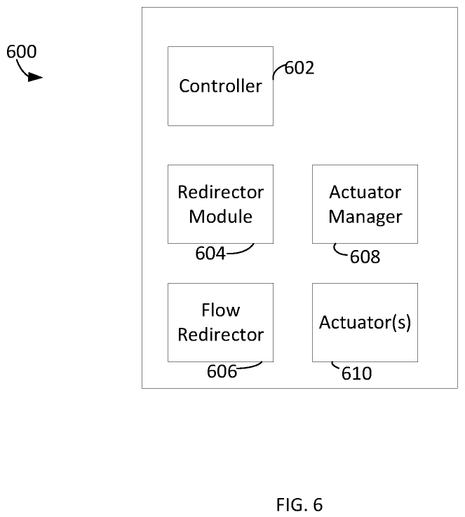

FIG. 6 illustrates an enforcer 600 according to an example. The enforcer 600 includes a controller 602, a redirector manager 604, a flow redirector 606, an actuator manager 608, and one or more actuators (actuators) 610.

The controller 602 controls the general operation of the enforcer 600, and can communicate with the supervisor (for example, the supervisor 106 of FIG. 1) to receive instructions on which flows to manage and what target QoS levels to enforce for those flows. The redirector manager 604 uses instructions received from the supervisor to determine how to redirect flows to reach a targeted QoS level. For example, the redirector manager may determine that a first flow requires more bandwidth because it is higher priority than a second flow, and thus may divert the first and second flow such that bandwidth from the second flow can be redirected to the first flow. The redirector manager 604 controls the flow redirector 606 to divert the flows (e.g., the first and second flows) to the actuators 610.

The flow redirector 606 directly interfaces with a network switch or other type of network node to intervene with flows on or passing through or being routed by that node. The flow redirector 606 may take targeted flow and redirect those flows to actuators. In some examples, the flow redirector 606 may use a communications protocol that gives access to the forwarding plane of the node to redirect flows to the actuators. For example, the flow redirector 606 may use OpenFlow or a similar protocol to redirect flows to the actuators.

The actuator resource manager 608 allows an enforcer to manage many actuators. As the number of actuators increases, the actuator resource manager 608 may determine how and where to place actuators and how resources are recycled as the need for actuators increases and decreases. The actuator resource manager 608 may determine which actuators 610 are active. The actuator resource manager 608 may horizontally scale the number and/or capacity of actuators 610 across an actuation cluster of one or more actuators 610.

The actuators 610 execute the QoS changes. For example, the actuators 610 may implement policies used to control competition for bandwidth by the various flows. In particular, the actuators 610 may adjust bandwidth parameters and other aspects of nodes in the network such that the supervisor's game is actually implemented. The actuators 610 may cause, in this manner, one or more flows to outcompete one or more other flows, including enterprise and/or non-enterprise flows, thus causing high priority flows to gain bandwidth and low priority flows to lose bandwidth. In some examples, the bandwidth transferred from flow to flow will not cause a significant change in the enterprise capacity of the user.

In some examples, the actuators 610 are transparent TCP proxies (or transparent transport protocol proxies) that can control a node's network congestion control algorithm. For example, to encourage a high priority flow to outcompete silver flows, the actuators 610 can cause the flow's congestion control algorithm (that acquires bandwidth) to operate like a plurality or aggregation of multiple flows. By operating the flow as multiple flows, the transport protocol will acquire more bandwidth for the flow. In more general terms, the enforcer 600 can cause a single flow to operate as (or be perceived as) multiple flows by a node in the network, the network, and/or the transport protocol.

In some examples, operating a single flow as multiple flows (or, conversely, a single flow as a smaller flow) can be accomplished using the CUBIC congestion control algorithm and adjusting the β variable to cause the flow to behave like more than one individual flows or to behave like a smaller flow. The relationship may be given by the equation:

$$Number of Flows = \frac{{β}_{default}}{β} \qquad ( 1 )$$

where number of flows is the number of flows a single flow would be operating as when the congestion control protocol is acquiring bandwidth, β is the adjusted value of the β variable, and β_{default} is the default value of β on the network. In other examples, the CUBIC C parameter may be scaled instead, and in other examples, a flow may be striped over multiple paths. However, the techniques and systems described herein are not limited to only the algorithms described with respect to TCP or to the CUBIC congestion control algorithm.

The enforcer 600 may also be configured to receive information regarding flow rates and bandwidth distributions of flows associated with the node where the enforcer 600 is located. The controller 602 may receive flow rate and bandwidth distribution information from the node or from any of the other subcomponents of the enforcer 600, and may relay said information to the supervisor.

FIG. 7A illustrates a process 700 for managing the headroom of one or more flows according to an example. The process 700 allows a supervisor to provide additional bandwidth to a flow, even when that flow has met or exceeded a target bandwidth level. Bandwidth distributed to a flow beyond the flow's target bandwidth level is called headroom. In some examples, a flow may benefit from additional headroom. For example, a video stream flow may have a target bandwidth level corresponding to a minimum QoS or minimum video resolution. If the video stream flow is using its full target bandwidth, it may be beneficial to distribute additional bandwidth (that is, headroom) to the flow. An increase in headroom may allow the flow to use the additional headroom to provide a higher QoS (for example, a higher video resolution). Likewise, if a flow is not using the headroom distributed to said flow, the process 700 allows for a supervisor to decrease the headroom of said flow and provide the freed up bandwidth to another flow. It will be appreciated that this process does not provide for the supervisor to reduce a flow's bandwidth below the target bandwidth level associated with that flow. Thus, the manipulation of headroom is, in some examples, limited to only bandwidth in excess of the target bandwidth level of the flow. However, in other examples, the process 700 could apply to any or all of the bandwidth of the flow, including both headroom and the target bandwidth level bandwidth.

At act 702, the supervisor determines whether a new flow is present at a given node or nodes. In some examples, the new flow is an enterprise flow. The supervisor may determine that the new flow is present based on inputs from the analytics or feedback provided by the enforcer. If the supervisor determines that a new flow is present (702 YES), the process 700 continues to a rebalancing process 750, which will be discussed in greater detail with respect to FIG. 7B. If the supervisor determines that a new flow is not present (702 NO), the process continues to act 704.

At act 704, the supervisor determines whether a flow is below a target bandwidth. In some examples, the flow will be an enterprise flow (e.g., will not be a non-enterprise flow). The supervisor may determine if the flow is below the target bandwidth using the analytics or feedback from the enforcer. If the supervisor determines the flow is below the target bandwidth (704 YES), the process 700 continues to the rebalancing process 750. If the supervisor determines the flow is not below the target bandwidth (704 NO), the process continues to act 706.

At act 706, the supervisor determines if any flow has gone idle. An idle flow may be a flow that is no longer present, a flow that has been deactivated or blocked, a flow that is not sending packets, and so forth. The supervisor may determine whether a flow is idle using the analytics or feedback from the enforcers. If the supervisor determines that a flow has gone idle (706 YES), the process 700 continues to the rebalancing process 750. If the supervisor determines that no flow has gone idle (706 NO), the process continues to act 708.

At act 708, the supervisor determines if a flow is using all or a threshold portion of the headroom (that is, all the available bandwidth) distributed to said flow. The supervisor may determine if a flow is using all or a threshold portion of the headroom distributed to said flow using the analytics or feedback from the enforcer. If the supervisor determines that the flow is using all or a threshold portion of the headroom (708 YES), the process may continue to act 710. If the supervisor determines that the flow is not using all or a threshold portion of the headroom (708 NO), the process 700 may continue to act 712.

At act 710, the supervisor controls the enforcers to increase the headroom of at least one flow that is fully using (that is, using all or at least a threshold portion of the headroom) the flow's respective headroom. For example, the supervisor may have distributed 10 Mbps to a flow, and the flow may be using the full 10 Mbps. The supervisor may then distribute an additional 1 Mbps (or any other amount of bandwidth) to the flow, such that the flow now has 11 Mbps to use. The process 700 may then return to act 702.

At act 712, the supervisor determines if a flow is not using all or a threshold portion of the headroom distributed to said flow. The supervisor may determine if a flow is not using all or a threshold portion of the headroom distributed to said flow by using the analytics or feedback from the enforcers. If the supervisor determines the flow is not using all or a threshold portion of the headroom (712 YES), the process 700 continues to act 716. If the supervisor determines the flow is using all or a threshold portion of the headroom (712 NO), the process may return to act 702.

At act 716, the supervisor controls the enforcers to decrease the headroom of at least one flow that is not fully using the flow's respective headroom. For example, the supervisor may have distributed 10 Mbps to the flow, but the flow is only using 8 Mbps. The supervisor may then reduce the headroom to 9 Mbps or 8 Mbps, or another value. However, in some examples, the supervisor will not control the enforcers to reduce the headroom below the minimum bandwidth targeted for the flow (that is, an enterprise flow will not be reduced below its respective target bandwidth level). For example, if the target bandwidth level of the flow is 5 Mbps, the supervisor will not reduce the bandwidth of the flow below 5 Mbps as part of the process 700 (but may reduce the bandwidth of the flow below the target bandwidth level for other reasons that may arise as part of other processes).

The acts of the process 700 may occur in any order. For example, acts 708 and 712 may occur at the same time following act 706 or another act (for example, 702 or 704). Acts 702, 704, and 706 may occur in any order with respect to one another.

FIG. 7B illustrates a rebalancing process 750 according to an example.

At act 752, the supervisor determines if a flow went idle (for example, at act 706 of the process 700). If the supervisor determines that a flow went idle (752 YES), the process 750 may continue to act 754. If the supervisor determines that a flow did not go idle (752 NO), the process 750 may continue to act 760.

At act 754, the supervisor controls the enforcers to distribute the entire bandwidth of the idle flow (including headroom and bandwidth corresponding to the target bandwidth level) to any flows that are below their respective target bandwidth levels or which could use additional headroom (collectively, “needy flows”). In some examples, the supervisor prioritizes distribution of the freed up bandwidth of the idle flow to flows below their target bandwidth level before flows that could use additional headroom to deliver improved QoS. The process 750 may then continue to act 756.

At act 756, the supervisor determines whether any additional bandwidth remains after the distribution of the bandwidth during act 754. If the supervisor determines that excess bandwidth remains (756 YES), the process 750 may continue to act 758. If the supervisor determines that no excess bandwidth remains (756 NO), the process 750 may continue to act 770.

At act 758, the supervisor controls the enforcers to release the excess bandwidth (that is, the bandwidth of the idle flow that was not distributed to needy flows) to non-enterprise flows.

At act 760, the supervisor determines if a new flow or a flow below the target bandwidth level for said flow is below the target bandwidth level for said flow. That is, for a new flow, the supervisor will check whether the new flow is at or above its target bandwidth level, and for an existing flow, the supervisor will check whether the flow is at or above its target bandwidth level. If the supervisor determines the flow is below the target bandwidth level (760 YES), the process 750 may continue to act 762. If the supervisor determines that the flow is above the target bandwidth level (760 NO), the process 750 may continue to act 770.

At act 762, the supervisor controls the enforcers to reduce the bandwidth of competing bronze flows and distributes the bandwidth of the competing bronze flow to the flow below the target bandwidth level. In some examples, the supervisor will not reduce the bandwidth of the competing bronze flows below the target bandwidth level for the competing bronze flows. The process 750 then continues to act 764.

At act 764, the supervisor determines whether the flow is at or above the target bandwidth level associated with said flow. If the supervisor determines the flow is below the target bandwidth level (764 YES), the process 750 may continue to act 766. If the supervisor determines that the flow is at or above the target bandwidth level, the process 750 may continue to act 770.

At act 766, the supervisor determines whether any competing gold flows have headroom (that is, whether any competing gold flows have bandwidth above their respective target bandwidth levels). If the supervisor determines that any gold flows have headroom (766 YES), the process 750 continues to act 768. If the supervisor determines than no gold flows have headroom (766 NO), the process 750 continues to act 770.

At act 768, the supervisor controls the enforcers to redistribute the headroom of one or more of the gold flows to the needy flow. In some examples, the supervisor will not control the enforcers to redistribute bandwidth of the gold flows such that the bandwidth of the gold flows would fall below the target bandwidth level for the gold flows.

At act 770, the process 750 may end in some manner. The process 750 may, for example, return to act 702 of the process 700 of FIG. 7A, may simply stop, or may return to act 752 of process 750.

In the foregoing discussion of FIGS. 7A and 7B, the QoS level may be altered by the supervisor instead of or in addition to bandwidth and/or headroom for each act of the process 700 of FIG. 7. In the foregoing discussion, a competing flow refers to a flow competing for bandwidth with the other flow (that is, in at least some examples, competing flows refers to at least two flows sharing a bottleneck at a given point in time).

For idle flows, such as flows that have closed or are not being used, the enforcer may redistribute all available bandwidth to other competing flows that are below their respective target bandwidths. If all flows are meeting their respective target bandwidths, the enforcer may release any excess bandwidth to the non-enterprise flows.

Various controllers, such as the enforcer 108, may execute various operations discussed above. Using data stored in associated memory and/or storage, the controller also executes one or more instructions stored on one or more non-transitory computer-readable media, which the controller may include and/or be coupled to, that may result in manipulated data. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A method of managing flows on a network comprising:
identifying a first flow on the network;
identifying a second flow on the network;
responsive to identifying the first flow, determining a priority of the first flow;
responsive to identifying the second flow, determining a priority of the second flow;
comparing the priority of the first flow to the priority of the second flow to determine which flow has the lower priority; and
distributing bandwidth from a flow having lower priority to a flow having higher priority.

2. The method of claim 1 wherein distributing bandwidth from the flow having lower priority to the flow having higher priority includes determining that the flow having higher priority and the flow having lower priority share at least one bottleneck link.

3. The method of claim 1 further comprising:
determining a bandwidth of the flow having lower priority;
determining a bandwidth of the flow having higher priority; and
wherein distributing bandwidth from the flow having lower priority to the flow having higher priority includes distributing no more bandwidth than the bandwidth of the flow having the lower priority.

4. The method of claim 1 further comprising:
determining a target bandwidth for the flow having the higher priority;
responsive to determining the target bandwidth, determining a bandwidth of the flow having the higher priority;
determining that the bandwidth is below the target bandwidth; and
wherein distributing bandwidth from the flow having the lower priority to the flow having the higher priority includes distributing an amount of bandwidth from the flow having the lower priority such that the bandwidth of the flow having the higher priority does not exceed the target bandwidth.

5. The method of claim 1 wherein distributing bandwidth includes using a competitive algorithm to distribute bandwidth, and the competitive algorithm is configured to favor the flow having the higher priority over at least one other flow.

6. The method of claim 5 wherein the at least one other flow is the flow having the lower priority.

7. The method of claim 5 wherein the at least one other flow is every flow present at a bottleneck link associated with the flow having the higher priority.

8. A method of distributing bandwidth on a network comprising:
providing at least one rule;
identifying at least two flows;
responsive to identifying the at least two flows, assigning two or more flows of the at least two flows a respective priority based on the at least one rule;
responsive to assigning the two or more flows of the at least two flows a priority, distributing bandwidth of at least one flow of the at least two flows to a different flow of the at least two flows.

9. The method of claim 8 further comprising identifying at least one bottleneck link shared by the at least two flows.

10. The method of claim 8 further comprising:
identifying a bandwidth of a first flow of the at least two flows;
identifying a bandwidth of a second flow of the at least two flows, the second flow having a priority lower than the first flow; and
wherein distributing bandwidth of the at least one flow of the at least two flows to a different flow of the at least two flows includes distributing bandwidth from the second flow to the first flow.

11. The method of claim 10 wherein the bandwidth distributed from the second flow to the first flow is less than or equal to the bandwidth of the second flow.

12. The method of claim 8 further comprising:
determining a target bandwidth for flows having a first priority;
wherein distributing bandwidth of the at least one flow of the at least two flows to a different flow of the at least two flows includes:
determining whether the flows having the first priority have a bandwidth exceeding the target bandwidth;
determining whether flows having a second priority, the second priority being less than the first priority, have bandwidth;
responsive to determining that the flows having the first priority do not have a bandwidth exceeding the target bandwidth and the flows having the second priority have bandwidth, distributing bandwidth from at least one flow having the second priority to at least one flow having the first priority.

13. The method of claim 8 wherein distributing bandwidth includes using a competitive algorithm, wherein the competitive algorithm is configured to favor the different flow of the at least two flows over the at least one flow of the at least two flows.

14. A dynamic quality management system (DQM) comprising:
a supervisor configured to provide bandwidth distributions for one or more flows; and
an enforcer configured to receive the bandwidth distributions for the one or more flows, the enforcer being further configured to
control a distribution of bandwidth for a first classification of flows routed through a network switch; and
control a distribution of bandwidth for a second classification of flows routed through the network switch.

15. The DQM of claim 14 wherein the enforcer is further configured to:
monitor a flow rate of the first classification of flows;
monitor a flow rate of the second classification of flows; and
compare the flow rate of the first classification of flows to a target flow rate.

16. The DQM of claim 15 wherein the enforcer is further configured to distribute bandwidth from the second classification of flows to the first classification of flows responsive to determining that the flow rate of the first classification of flows is below the target flow rate.

17. The DQM of claim 16 wherein the enforcer is further configured to maintain the sum of the flow rate of the first classification of flows and the flow rate of the second classification of flows at an approximately constant level based on the bandwidth of the network switch.

18. The DQM of claim 14 wherein the enforcer is further configured to identify a bottleneck link having at least one first flow of the one or more flows and at least one second flow of the one or more flows routed through a network switch associated with the bottleneck link.

19. The DQM of claim 18 wherein the enforcer is installed on the network switch associated with the bottleneck link.

20. The DQM of claim 18 wherein the enforcer is configured to determine the network switch associated with the bottleneck link based at least on flow rate information associated with the one or more flows provided to the enforcer by at least one other enforcer.
